(19) United States
(12) Patent Application Publication
(10) Pub. No.: US 2010/0088129 A1
(43) Pub. Date: Apr. 8, 2010

(54) Technology Selection and Pricing System

(76) Inventors: Chih-Shih Wei, Hsin-Chu (TW); Ji-Chung Huang, Hsin-Chu (TW); Ssu-Ying Chen, Hualien CIty (TW); Hwa-Yu Yang, Hsin-Chu (TW)

Correspondence Address: SLATER & MATSIL, L.L.P., 17950 PRESTON ROAD, SUITE 1000, DALLAS, TX, 75252, US

(21) Appl. No.: 12/245,247

(22) Filed: Oct. 3, 2008

(51) Int. Cl. G06Q 10/00; G06Q 30/00; G06Q 50/00

(52) U.S. Cl. 705/7; 705/400

(57) ABSTRACT

A method of selecting a technology for manufacturing an integrated circuit includes designating candidate technologies for manufacturing the integrated circuit; generating design and performance data from the integrated circuit, wherein the design and performance data are generated for each of the candidate technologies; and generating die prices from the integrated circuit, wherein the die prices are generated for each of the candidate technologies.

### TECHNICAL FIELD

This invention relates generally to a custom technology selection and pricing system, and more particularly to the system for guiding customers to select a suitable technology for manufacturing integrated circuits based upon performance, price, intellectual property (IP) availability, and/or mask non-recurring expenses.

### BACKGROUND

Accurate pricing is critical for a manufacturer to profitably manufacture custom chips (dies). The manufacturer must accurately anticipate the cost of manufacturing the chips and factor-in a desirable profit to achieve a final price. The manufacturer that over-estimates the manufacturing cost will lose business to other manufacturers. On the other hand, the manufacturer that under-estimates the manufacturing cost will fail to profit from the manufacturing work.

The manufacturer generally seeks to minimize the time required for a customer to place an order while simultaneously minimizing the burden on its own operation. This allows for faster orders at a lower cost. Also, a higher degree of customer satisfaction may be achieved. Accurate and timely pricing for different custom chips (with or without the need of custom packaging) is thus important from both the customer and the manufacturer perspectives.

The existing pricing process is inefficient and confusing for a customer. For example, the manufacturer typically provides a customer with a price guide in the form of a spreadsheet. The price guide may contain entries for various solutions, including custom die options and packaging options. The customer then tries to find a solution and to determine the corresponding cost. However, if the customer desires to make modifications to the solutions provided by the manufacturer, the quote also needs to be customized. The manufacturer and the customer may need many interactions before a satisfactory price/performance trade-off is made. Such a pricing process is typically time-consuming. Frustrated by this pricing process, the customer may be dissatisfied with the manufacturer, and eventually seek other manufacturers.

On the other hand, engineers from the manufacturer were frequently required to analyze the custom solutions provided by the customer. This process is time consuming and results in inefficient use of the engineers' skills.

In addition, in the case that after a price is provided, and the customer changes ideas and determines to manufacture the integrated circuit using a different technology, the above-discussed process needs to be started over, and the effort already spent is wasted. Further, the existing pricing process only has the ability to make pricing based on the existing technology used for mass production. For future generations of technologies that have not been used in mass production, the existing pricing system is not capable of providing the quote due to a lack of information, for example, the yield. A new system having a greater level of flexibility and requiring less resources is thus needed.

### SUMMARY OF THE INVENTION

In accordance with one aspect of the present invention, a method of selecting a technology for manufacturing an integrated circuit includes designating candidate technologies for manufacturing the integrated circuit; generating design and performance data from the integrated circuit, wherein the design and performance data are generated for each of the candidate technologies; and generating die prices from the integrated circuit, wherein the die prices are generated for each of the candidate technologies.

In accordance with another aspect of the present invention, a method of selecting a technology for manufacturing an integrated circuit includes determining candidate technologies for manufacturing the integrated circuit; determining candidate time frames for manufacturing the integrated circuit; generating design and performance data from the integrated circuit, wherein the design and performance data are generated for each of the candidate technologies; and generating die prices from the integrated circuit, wherein the die prices are generated for each of the candidate technologies and for each of the candidate time frames.

In accordance with yet another aspect of the present invention, a custom technology selection and pricing system for manufacturing an integrated circuit includes a design calculator for generating design and performance data from the integrated circuit, wherein the design and performance data are generated for each of a plurality of candidate technologies; and a die price forecast module for generating die prices of the integrated circuit, wherein the die prices are generated for each of the plurality of candidate technologies.

In accordance with yet another aspect of the present invention, a custom technology selection and pricing system for manufacturing an integrated circuit includes a design calculator for generating design and performance data from the integrated circuit for each of a plurality of candidate technologies; a die price forecast module for generating die prices from the integrated circuit for each of the plurality of candidate technologies and for each of the plurality of time frames; and at least one of an intellectual property (IP) portfolio module and a mask calculating module. The IP portfolio module is configured to provide IP availability information for the plurality of candidate technologies and for a plurality of future time frames. The mask calculating module is configured to generate mask non-recurring expense information for the integrated circuit and for at least one of the candidate technologies.

The advantageous features of the present invention include reduced time and effort for generating a price quote, and the possibility for selecting a most appropriate technology, even if the technology is not being used in mass production.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates a block diagram of an embodiment of the present invention;

FIG. 2 illustrates a process of the embodiment of the present invention; and

FIG. 3 illustrates a price/cost cross-over diagram for different technologies.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

A novel custom technology selection and pricing system is provided. A process for selecting an appropriate technology and determining the respective price is provided, wherein the technology selection involves selecting a list of candidate technologies that may possibly be used for manufacturing an integrated circuit provided by a customer, and providing the information of the candidate technologies for the customer to select an appropriate technology.

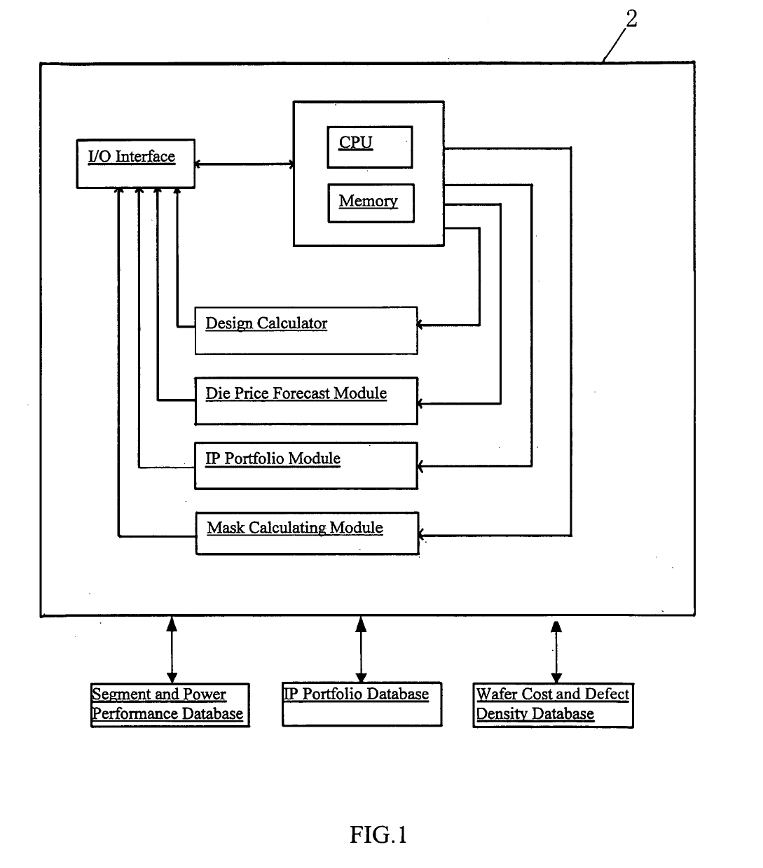

FIG. 1 illustrates a schematic diagram of the embodiments of the present invention. Custom technology selection and pricing system 2 includes an input/output (I/O) interface for interacting with salespeople, engineers, customers, or the like. Custom technology selection and pricing system 2 includes a computer, which includes a computing unit (CPU) for processing tasks, and memories. Further, custom technology selection and pricing system 2 includes a design calculator, a die price forecast module, an intellectual property (IP) portfolio module, and a (cross-generation) mask calculating module. Various database systems, such as a segment and power performance database, an IP portfolio database, a wafer cost and defect density database, and/or the like, are connected to, and support, the operation of custom technology selection and pricing system 2. Alternatively, the above-discussed databases may be built in the custom technology selection and pricing system 2. The I/O interface is responsible for taking input, and outputting the generated results, such as design and performance data, die prices, IP availability information, and mask non-recurring expenses.

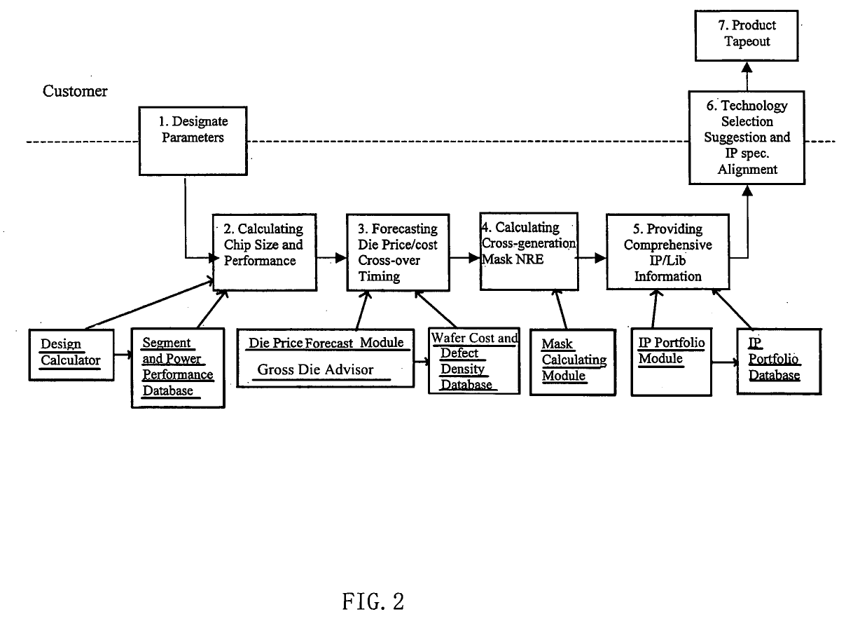

FIG. 2 illustrates a brief process for performing the embodiments of the present invention. In FIG. 2, a dotted line is drawn to show the boundary between a customer and a manufacturer, who manufactures chips (dies) incorporating the design of the integrated circuit provided by the customer. Accordingly, the blocks above the dotted line are actions involving the customer, the blocks under the dotted line are actions involving the manufacturer, and the blocks on the dotted line involve both the customer and the manufacturer. The blocks under the dotted line are also the tasks that may be performed by custom technology selection and pricing system 2.

In the beginning of a technology selection and pricing process (block 1), designated parameters regarding the design and manufacturing are provided by the customer and/or the manufacturer, wherein the parameters include, but are not limited to, logic gate count, memory parameter, pin count, I/O pad pitch, I/O body height, macro, scribe line, wafer diameter, other information related to die size (ex: shrink ratio from generation to generation), package, interested technologies (level 1˜3), time period of interest, product segment, or the like. The designated parameters may be provided to the computer (refer to FIG. 1) using the I/O interface. It is noted that at any time, the manufacturer may have a list of available technologies (also referred to as technology nodes) for the customer to select. For example, the available technologies may include 90 nm technology, 65 nm technology, and 45 nm technology. The technologies include mature technologies that are already used in mass production, and may include the technologies that will be available for mass production in a future time frame at which the integrated circuit is to be manufactured. Based on the information provided by the customer regarding the design of the integrated circuit, a list of candidate technologies that might be suitable for manufacturing the integrated circuit is selected for further analysis, as described in blocks 2, 3, 4, and 5. From the analysis results, a most suitable technology may be selected. The details of the analysis are provided below.

To determine the most suitable technology, the design data (for example, chip size) and performance data of the integrated circuit are evaluated and compared for each of the candidate technologies. This step is shown in block 2. The function in block 2 is implemented using a design calculator, which may interact with the segment and power performance database. To achieve this function, simulation program for integrated circuits emphasis (SPICE) models may be used to simulate the integrated circuit provided by the customer, wherein the SPICE model simulation is performed for each of the candidate technologies. The results of the SPICE simulation are referred to as performance data hereinafter, and may include power, leakage, speed, and the like. Accordingly, it can be determined which of the technologies from the candidate technologies meet the performance requirement.

The design calculator has the further function of forecasting the performance data. If a more advanced SPICE model is, or to be, available for a technology not being used in mass production, the manufacturer may suggest the customer to consider using the updated SPICE model. Further, since the future technologies typically have improved performance, the design calculator may provide the forecast, and optimizes the design and performance targets for future ones of the candidate technologies. Accordingly, it can be forecasted what the performance data will be if the integrated circuit is manufactured using future technologies that are not yet being used in mass production. Therefore, the customer may anticipate the performance data of the integrated circuits manufactured using a new technology (and in a future time). Therefore, the design calculator makes it possible for the customer to select a technology that has not yet rolled out, but will be rolled out at the time (referred to as manufacturing time hereinafter) the customer wants the integrated circuit to be implemented on chips. Overall, the design calculator may provide the design and performance data for each of a plurality of candidate manufacturing time frames, for example, quarters of years.

Referring to block 3 of FIG. 2, the function of forecasting die price and determining cross-over timing is performed by a die price forecast module, which may interact with the wafer cost and defect density database that stores defect densities. The die price of a die is equal to the price for manufacturing the respective wafer (from which the die is sawed) divided by the number of good dies in the wafer. The details for determining the die price are discussed below.

The wafer price is affected by various factors, including the design of the wafer, the technology for manufacturing the wafer, and the time frame (for example, by quarters of years) for manufacturing the integrated circuit. In an exemplary embodiment, the price of the wafer is affected by several levels of factors, including level-1 factors such as geometry, technology level, device level, process level, poly layers, poly gate material, voltage, phase in, fabrication specification, process simplification, minimum metal, maximum metal, and the like. The price of the wafer is also affected by level-2 factors related to mask formation, such as mask sequence, code, usage, grade, type, optical proximity correction (OPC), phase shift masking (PSM), digitized tone, scribe tone, CAD bias, or the like. Further, level-3 factors such as the number of layers also affect the price of the wafer.

A gross die advisor is used to determine the number of good dies on a wafer, wherein the gross die advisor may be used to optimize gross die per wafer with improved mask field utilization rate. The gross die advisor uses several factors to determine the number of gross dies on the wafer, including the size of the dies, the size of scribe lines between the dies, the technology node, and the diameter of the wafer. The gross die advisor may also factor in the fabrication condition, such as which of the plants will be used to manufacture the dies.

The number of good dies on the wafer is equal to the number of gross dies times yield. In an exemplary embodiment, the yield may be roughly expressed as:

Yield=1/(1+D₀A)^{N} [Eq. 1]

wherein A is the critical area of the integrated circuit to be manufactured, and D₀ is the defect density per unit critical area. N is referred to as an N factor, and is the sum of the complexity factors by layers. The levels that contribute to the N factor include the above-discussed level-1 factors, level-2 factors, and level-3 factors. It is to be noted that since both the wafer price and the yield are affected by the level-1, level-2, and level-3 factors, the forecast of the wafer price and the yield should be based on same values as the level-1, level-2, and level-3 factors.

Defect density D₀ is related to the time frame for manufacturing the integrated circuit, and reflects the yield on manufacturing lines for a certain period of time. In an embodiment, defect density D₀ may be obtained from a test vehicle, and/or from real manufacturing lines. Further, defect density D₀ may be adjusted based on several factors, such as the technology, the manufacturing time frame, the percentage of memory area (without redundancy), and the number of gross die per wafer. The forecast may be, for example, a two-year forecast with die prices forecasted for each of the quarters.

As discussed in the preceding paragraph, the yield may be obtained from manufacturing lines if the respective technology is already used for mass production, or from test lines if the respective technology has not been used for mass production. The yield may also be pure estimation based on empirical data for future generations of technologies. It is noted that the yield of the embodiments of the present invention is related to the technology and the time frame, and if different technology is used, or the dies are to be manufactured at a different time frame, the yield will be different. For example, a newer technology typically has a lower yield than an older technology, and over time, for a same technology, the yield improves.

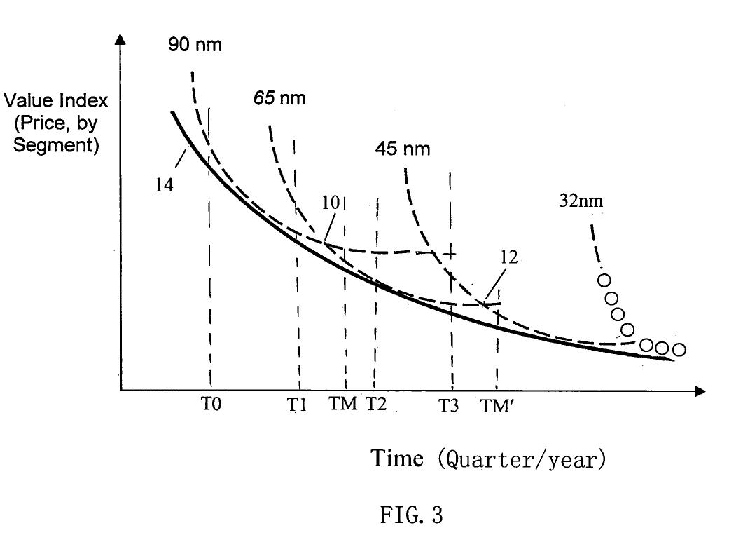

Since both the wafer price and the yield are related to the technology and the manufacturing time frame, the die prices are related to the technology and the manufacturing time frame. Hence, the die prices may be calculated for each of the candidate technologies and for each of the manufacturing time frames. FIG. 3 illustrates the die prices as a function of manufacturing time frames, wherein the die prices are generated by product segments. In other words, if two dies whose integrated circuits belong to different product segments, the respective die price figure (verses time) may be different. It is noted that for each of the technologies, for example, 90 nm, 65 nm, and 45 nm technologies, the die price decreases over time. This is attributed to the improvement in the yield, and the reduction in the wafer price. For a certain technology, the die price may eventually stabilize. The newer technologies will have higher die prices than older technologies in the beginning. However, over time, the die prices of newer technologies will eventually be equal to, and less than the die prices of older technologies. Time points 10 and 12, at which the die prices of older technologies equals to the die prices of newer technologies, are break-even points, which are important reference points for comparing the costs of newer and older technologies. The manufacturer may want to suggest using a newer technology if the die price of the newer technology is lower than the die price of an older technology by a non-zero margin (time points TM and TM′), which has pre-determined value. Otherwise, the manufacturer may still want to suggest using the older technology. The points of time when the cross-over (with the non-zero margin) occur, for example, time points TM and TM¹ in FIG. 3, are referred to as cross-over timing. In alternative embodiments, at the break-even points, newer technologies may be selected for manufacturing the integrated circuit. The die price forecast module may provide the die price cross-over analysis result, for example, in the form shown in FIG. 3 to the manufacturer and the customer for them to make decisions, or in any other forms, such as spreadsheets.

It is noted that at any time, there may be several technologies available, each having their own die price. Assuming at time T0, the manufacturer and the customer meet to determine a price quote, depending on when the customer wants the integrated circuit to be manufactured, the options of available technologies may be different. For example, if the customer wants the manufacturing time to be T1, there will be 90 nm and 65 nm technologies available. If the customer wants the manufacturing time to be T3, there are 90 nm, 65 nm, and 45 nm technologies available. Conversely, if the customer wants the manufacturing to be done immediately (at T0), there will be only 90 nm technology (and possibly older generations of technologies) available. If the manufacturing time is T1, the customer may choose the 90 nm technology since the die price of the 65 nm technology is far higher than the die price of the 90 nm technology. However, if the manufacturing time is T2, the customer may choose the 65 nm technology since time point T2 is after the die price cross-over timing TM.

It is noted that the 90 nm, 65 nm, and 45 nm technology lines form trend line 14. In the embodiments of the present invention, trend line 14 may be used to estimate the trend of the future generations of technologies, for example, a 32 nm die price line may be estimated as shown in FIG. 3, wherein the 32 nm die price line is also expected to fit trend line 14.

Referring back to FIG. 2, block 4 illustrates a mask calculating module for forecasting mask non-recurring expense (NRE). If the customer selects a future generation of technologies, it is likely that in the first tape-out, some of the functions may not work properly, and hence re-tape-out may be needed, and the cost of revision and re-tape-out are needed. In this case, the manufacturer may inform the customer of the expected cost for the re-tape-out. The customer may then decide whether he/she wants to take the risk of re-tape-out (as a possible consequence of selecting a newer technology) in light of the possible NRE.

Referring to FIG. 2 again, in block 5, comprehensive IP/Lib (library) information is provided by an IP portfolio module, which interacts with an IP portfolio database. The IP portfolio module is capable of providing the IP availability information sorted by segments, by technologies, by types, and/or by vendors. For example, the IP portfolio module may provide only the IP information related to the integrated circuit to be manufactured, depending on the segment of the integrated circuit, such as whether the integrated circuit is a base band design, a consumer product, a graphic design, or the like. The IP portfolio module may also tell the user which IPs are available for each of the technologies, each of the IP vendors, and each of the IP types. Advantageously, the customer may focus only on the IPs related to his/her specific design without wasting time on un-related IPs. The customer may also determine the suitable technology based on the availability and the performance of the available IPs. In addition, the IP portfolio module may provide the schedule of the release of certain IPs if they are not currently available; the customer may then select the technology not only based on the current availability, but also according to whether the IPs will be released early enough for the manufacturing of the integrated circuit.

In addition, the IP portfolio module provides the ability for customers to provide feedback to the manufacturer with comments. These comments may include IP specification alignment comments such as the customer's desire for certain IPs to be released earlier. These comments may also include performance requirements of the IPs, for example, whether the customers prefer the speed or leakage current of certain IPs to be improved.

Although FIG. 2 illustrates that blocks 2 through 5 are sequenced, in the embodiments of the present invention, blocks 2 through 5 are performed by computers, and may be performed in any order. For each of the candidate technologies, a set of results obtained by executing the steps shown in blocks 2 through 5 is provided to the sales people of the manufacturer, and to the customer. The manufacturer may suggest a most appropriate one from the candidate technologies. The customer may evaluate the results and make trade-offs to select a most suitable technology among the candidate technologies. With the capability provided by the custom technology selection and pricing system 2, the customer may select the technology (block 6) not only according to the die price and the performance, but also according to the IP availability and mask NRE, and the time schedule of his/her design. After the customer selects the technology, tape-out can be made according to the selected technology and the available design and performance data, and the like (block 7).

The embodiments of the present invention have several advantageous features. By providing a plurality of technologies, including existing mass production technologies and future technologies, a customer may select the right technology, with optimized die price, performance, IP availability, and mask NRE. With all the technology possibilities presented simultaneously, the conventional time-wasting re-quote processes are no longer needed. In addition, manufacturers may provide the price quotes of future generations of technologies and manufacturing time frames. Furthermore, with the tasks of custom technology selection and pricing system being executed by a computer, the price quote time may be shortened from months or days to minutes.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, and composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method of selecting a technology for manufacturing an integrated circuit, the method comprising:
designating candidate technologies for manufacturing the integrated circuit;
generating design and performance data from the integrated circuit, wherein the design and performance data are generated for each of the candidate technologies; and
generating die prices from the integrated circuit, wherein the die prices are generated for each of the candidate technologies.

2. The method of claim 1 further comprising, based on the design and performance data and the die prices, selecting a technology from the candidate technologies for manufacturing the integrated circuit.

3. The method of claim 2, wherein the step of selecting the technology comprises determining cross-over timings between the candidate technologies.

4. The method of claim 1, wherein for at least one of the candidate technologies, the design and performance data comprise data generated for a future time frame.

5. The method of claim 1, wherein for at least one of the candidate technologies, the die prices are generated for each of a plurality of time frames.

6. The method of claim 5, wherein the plurality of time frames comprises a future time frame, and wherein the step of generating the die prices comprises forecasting a yield for the future time frame.

7. The method of claim 1 further comprising:
generating intellectual property (IP) availability information for the integrated circuit.

8. The method of claim 7, wherein the IP availability information is generated for each of a plurality of time frames.

9. The method of claim 7, wherein the IP availability information is generated according to product segments.

10. The method of claim 1 further comprising:
generating mask non-recurring expense information for the integrated circuit and for at least one of the candidate technologies, wherein the at least one of the candidate technologies is a non-mass-production technology.

11. A method of selecting a technology for manufacturing an integrated circuit, the method comprising:
determining candidate technologies for manufacturing the integrated circuit;
determining candidate time frames for manufacturing the integrated circuit;
generating design and performance data from the integrated circuit, wherein the design and performance data are generated for each of the candidate technologies; and
generating die prices from the integrated circuit, wherein the die prices are generated for each of the candidate technologies and for each of the candidate time frames.

12. The method of claim 11 further comprising providing the design and performance data and the die prices for a customer owning the integrated circuit to select one of the candidate technologies.

13. The method of claim 12, wherein the step of selecting one of the candidate technologies comprises determining a die price cross-over timing between two of the candidate technologies.

14. The method of claim 13, wherein the die price cross-over timing is at a time a first die price of a newer one of the candidate technologies is at least about a certain percent lower than an older one of the candidate technologies, wherein the certain percent has a pre-determined value.

15. The method of claim 11 further comprising determining intellectual property (IP) availability information for each of the candidate technologies and for each of the candidate time frames.

16. The method of claim 11 further comprising determining mask non-recurring expenses (NRE) for at least one of the candidate technologies.

17. The method of claim 11, wherein the candidate technologies comprise a technology not used in mass production.

18. The method of claim 11, wherein the candidate time frames are based on quarters of years.

19. The method of claim 11, wherein the step of generating the die prices comprises forecasting a yield for a future one of the candidate time frames.

20. The method of claim 19, wherein the step of forecasting the yield comprises:
predicting defect densities; and
adjusting the defect densities based on a parameter selected from the group consisting essentially of memory area, a number of gross die per wafer, and combinations thereof.

21. A custom technology selection and pricing system for manufacturing an integrated circuit, the custom technology selection and pricing system comprising:
a design calculator for generating design and performance data from the integrated circuit, wherein the design calculator is configured to generate the design and performance data for each of a plurality of candidate technologies; and
a die price forecast module for generating die prices of the integrated circuit, wherein the die price forecast module is configured to generate die prices for each of the plurality of candidate technologies.

22. The custom technology selection and pricing system of claim 21, wherein the design and performance data comprises chip size, power, leakage, and speed.

23. The custom technology selection and pricing system of claim 21, wherein the die price forecast module is configured to generate the die prices for a plurality of time frames for at least one of the candidate technologies.

24. The custom technology selection and pricing system of claim 23, wherein the die price forecast module is configured to forecast yields for at least one of the plurality of time frames and for the at least one of the candidate technologies.

25. The custom technology selection and pricing system of claim 24, wherein the plurality of time frames comprises a future time frame, and wherein the die price forecast module is configured to forecast a yield for the future time frame.

26. The custom technology selection and pricing system of claim 21 further comprising an intellectual property (IP) portfolio module configured to provide IP availability information for the plurality of candidate technologies and for a plurality of future time frames.

27. The custom technology selection and pricing system of claim 21 further comprising a mask calculating module configured to generate a mask non-recurring expense information for the integrated circuit and for at least one of the candidate technologies, wherein the at least one of the candidate technologies is a non-mass-production technology.

28. A custom technology selection and pricing system for manufacturing an integrated circuit, the custom technology selection and pricing system comprising:
a design calculator for generating design and performance data from the integrated circuit for each of a plurality of candidate technologies;
a die price forecast module for generating die prices from the integrated circuit for each of the plurality of candidate technologies and for each of the plurality of time frames; and
at least one of an intellectual property (IP) portfolio module and a mask calculating module, wherein the IP portfolio module is configured to provide IP availability information for the plurality of candidate technologies and for a plurality of future time frames, and the mask calculating module is configured to generate a mask non-recurring expense information for the integrated circuit and for at least one of the candidate technologies.

29. The custom technology selection and pricing system of claim 28 further comprising both the IP portfolio module and the mask calculating module.

30. The custom technology selection and pricing system of claim 28, wherein the design calculator is configured to forecast the design and performance data for at least a future one of the plurality of time frames and for at least one of the candidate technologies.

31. The custom technology selection and pricing system of claim 28, wherein the design and performance data comprise chip size, power, leakage, and speed.

32. The custom technology selection and pricing system of claim 28, wherein the die price forecast module is configured to forecast die prices for each of the plurality of time frames and for at least one of the candidate technologies not in mass production.

33. The custom technology selection and pricing system of claim 32, wherein the die price forecast module is configured to forecast yields for each of the plurality of time frames and for the at least one of the candidate technologies.

34. The custom technology selection and pricing system of claim 28, wherein the die price forecast module is configured to provide a die price cross-over analysis result, wherein the die prices for the plurality of candidate technologies are shown as a function of time frames.
